(19) United States
(12) Patent Application Publication
(10) Pub. No.: US 2009/0275004 A1
(43) Pub. Date: Nov. 5, 2009

(54) Feeding Aid

(76) Inventors: Jennifer Benson, Kingsmead (GB); Pamela Bellis, London (GB)

Correspondence Address: Fay Sharpe LLP, 1228 Euclid Avenue, 5th Floor, The Halle Building, Cleveland, OH, 44115, US

(21) Appl. No.: 12/501,402

(22) Filed: Jul. 10, 2009

Related U.S. Application Data
(63) Continuation of application No. 10/548,700, filed on Oct. 5, 2006.

(30) Foreign Application Priority Data
Mar. 11, 2003 (GB) 0305487.1
Jul. 18, 2003 (GB) 0316874.7

(51) Int. Cl. G09B 19/00

(52) U.S. Cl. 434/127

(57) ABSTRACT

A feeding aid for teaching children to feed themselves. The feeding aid includes a feeding implement (2), an anchor device (4) for fixing the feeding aid to a surface and a resilient member (6) connecting the feeding implement to the anchor device.

This invention relates to feeding aids and in particular, but not limited to, feeding aids for young children.

An essential step in the development of young children is when a child begins to eat solid foods. Weaning typically begins when children are around 4-6 months old. Initially, solid foods are blended or mashed into a pulp and are fed to the child by an adult using conventional feeding implements. The next stage of development is to teach the child to feed him/herself using feeding implements such as knives, forks and spoons. Normally a child is given an implement such as a baby spoon. This tends to be made of a plastics material and is lighter and shorter than spoons used by adults. A child will use the implement to scoop up a portion of food from a bowl and attempt to deliver it to his/her mouth.

Developing this skill can take several months or more. This can be a very frustrating time for parents since children often drop feeding implements onto the floor and the parents have to repeatedly stoop to retrieve the implement. This also presents a hygiene hazard since dirt, harmful bacteria and other infectious organisms may contaminate the implement when it contacts the floor. If the parent gives the implement back to the child without first washing it, the child may ingest the contaminants which may consequently damage the child's health. Therefore there is a need for a feeding aid that can assist the child to develop a controlled feeding action more quickly as well as preventing the feeding implement from falling onto the floor.

A similar problem exists for physically impaired people. Some impairments restrict a person's hand movement and coordination making feeding difficult. Such people would benefit from a feeding aid that assists feeding activity. Some conditions may also cause a person to more easily lose their grip on feeding implements. If the feeding implement falls onto the floor the person may not be able to retrieve it by themselves thereby requiring assistance of another individual.

Accordingly, the invention seeks to mitigate some of the afore-mentioned problems.

According to one aspect of the present invention there is provided a feeding aid including a feeding implement, an anchor device for fixing the feeding aid to a surface and a resilient member connecting the feeding implement to the anchor device.

Advantageously, the invention assists the child's development by reducing the amount of time it takes to learn to feed him/herself properly with a feeding implement. This is because when the child has completed a feeding action, the child tends to relax his/her arm and the resilient action of the resilient member tends to return the child's hand towards the anchor device. This has the effect of teaching the child to return his/her hand to approximately the same position after each feeding action has been completed which encourages the child to commence a subsequent feeding action.

Since the feeding aid is firmly anchored to a surface if the child loses its grip from on the feeding implement the feeding implement will be prevented from falling onto the floor. This reduces the risk of dirt and harmful bacteria migrating from the floor onto the eating implement and therefore preventing the child from ingesting such contaminants, thus benefiting the child's health.

Preferably the resilient member is made from a plastics material that has elastic properties. For example, the resilient member can be made from a thermoplastic rubber or elastomer, such as a phthalate free PVC material. Preferably the resilient member is coiled.

Advantageously the anchor device includes a suction device. Alternatively the anchor device may include a clip, a clamp or a bracelet.

Preferably the feeding implement includes a cavity having first and second openings, wherein one end of the resilient member is located in the cavity through the first opening and is attached to the feeding implement. Preferably the resilient member is attached to the feeding implement by a welding process such as an ultrasonic welding process. A plug is located in the second opening to close the second opening. The resilient member may additionally be clamped between the plug and the feeding implement. Preferably the cavity has a base and one of the cavity base and the plug includes a formation that is arranged to clamp the resilient member against the other. In one embodiment, the cavity has a first formation in its base and the plug has a second formation in its body, wherein the first and second formations are arranged to clamp the resilient member.

An embodiment of the invention will now be described, by way of example only, with reference to the accompanying drawings in which like references indicate equivalent features, wherein:

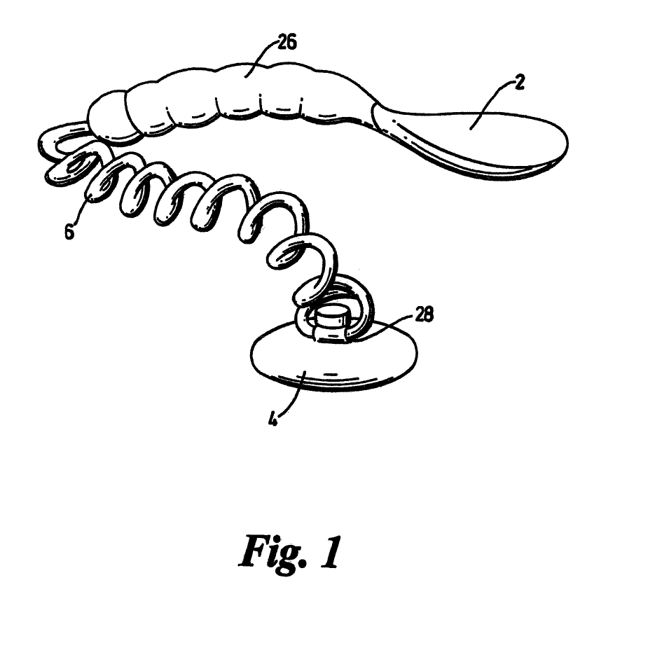

FIG. 1 is a perspective view of a feeding aid in accordance with the present invention;

FIG. 2 is a cross-section of a feeding implement;

FIG. 3 is an end view of a feeding implement;

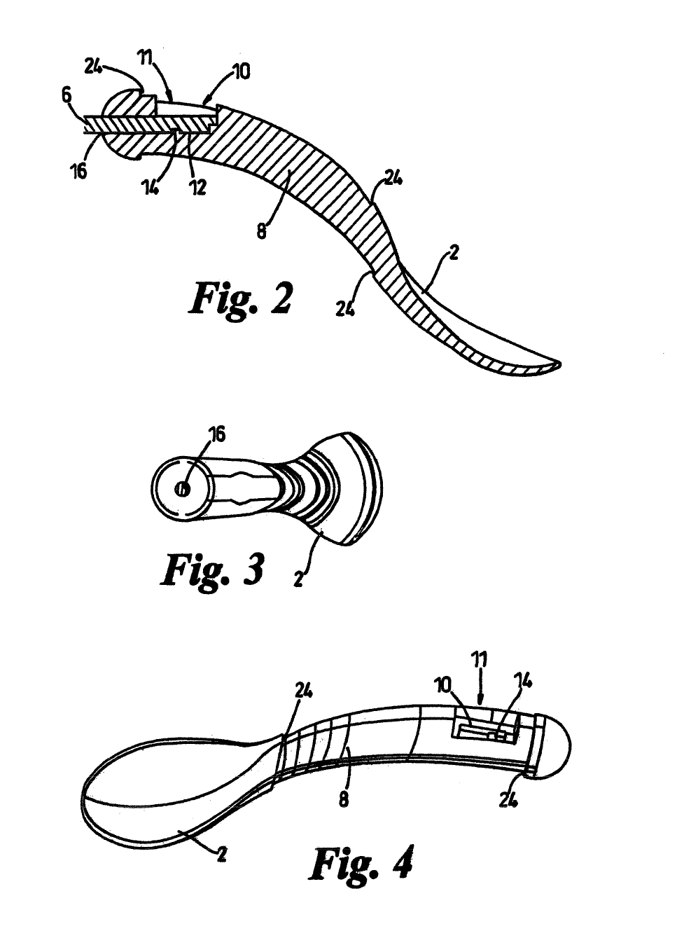

FIG. 4 is a side view of a feeding implement;

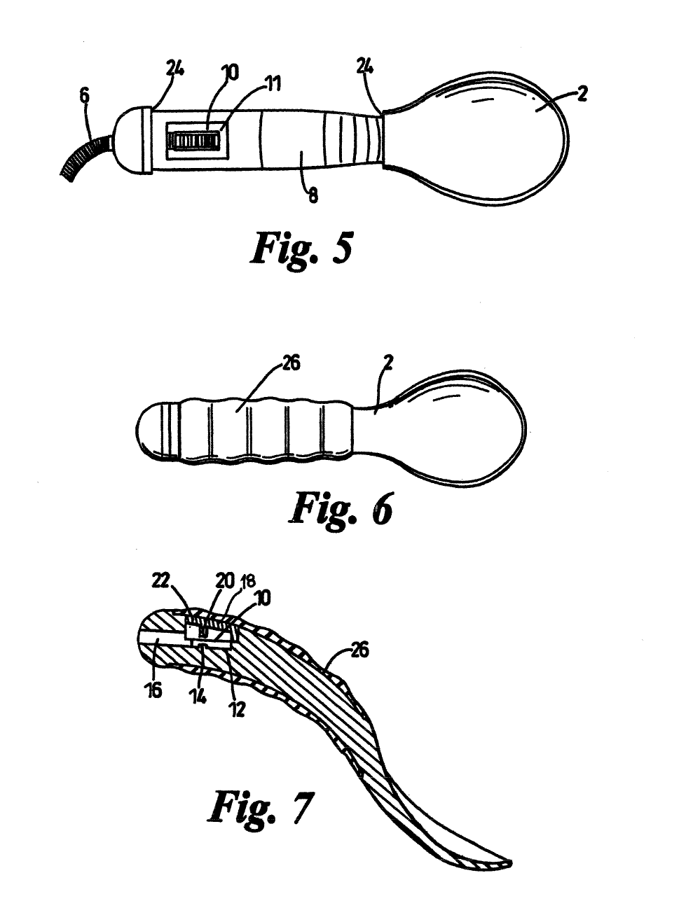

FIG. 5 is a top view of a feeding implement;

FIG. 6 is a top view of a feeding implement with a handgrip;

FIG. 7 is a cross-section of a feeding implement with a handgrip;

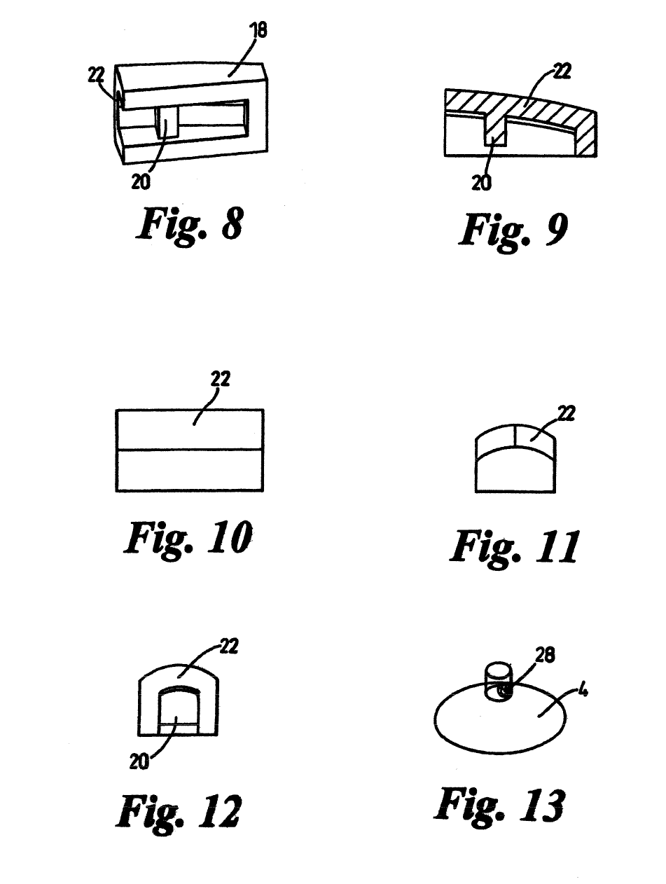

FIGS. 8-12 show various views of a plug for fitting into a cavity in the feeding implement;

FIG. 13 is a perspective view of a suction device; and

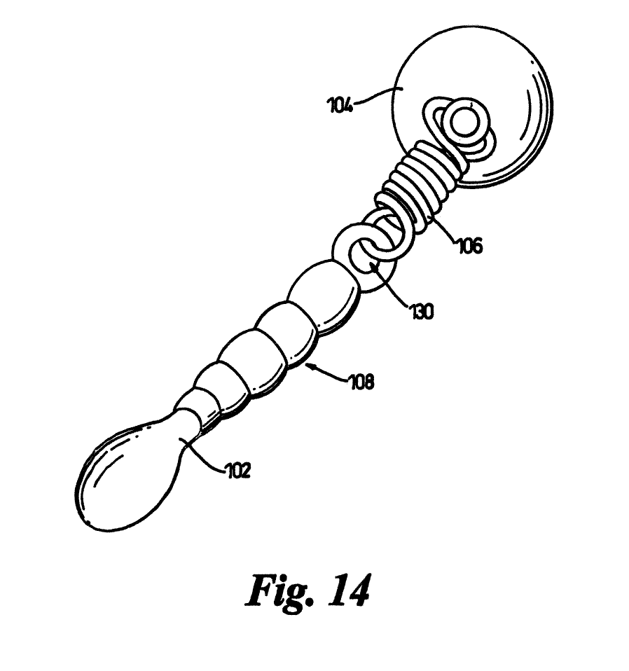

FIG. 14 is a perspective view of a second embodiment of the invention.

FIG. 1 shows a feeding aid including a feeding implement (spoon 2), an anchor device (suction cup 4) and a resilient member (connector member 6) that connects the spoon 2 to the suction cup 4.

The spoon 2 has an arcuate handle 8 that is suitable for gripping by a young child. The spoon 2 is preferably made from a plastics material such as polypropylene. Alternatively, the spoon 2 may be formed from a suitable metal such as stainless steel, although plastics materials are preferred as these tend to be lighter than metals and are kinder to children's gums and teeth (i.e. do less damage). Towards one end of the handle, there is a cavity 10 formed in the handle 8 (see FIGS. 2, 4, 5 and 7). The cavity 10 is substantially rectangular in plan view, is substantially aligned with the longitudinal axis of the spoon 2 and has an opening 11. The cavity 10 has a base 12 with a first rib 14 integrally formed therewith that extends across the width of the cavity 10. A bore 16 is formed in the end of the handle 8 that intersects the cavity 10. The bore 16 is arranged to receive one end of the connector member 6. The connector member 6 is threaded through the bore 16 and into the cavity 10 such that it lies over the first rib 14. The connector member 6 is attached to the base 12 of the cavity by an ultrasonic welding process.

A plug 18 is inserted into the opening 11. The plug 18 has a top plate 22 with an arcuate upper surface that lies flush with the handle 8 when the plug 18 is properly located. The plug 18 includes a second rib 20 that depends from the underside of the top plate and is arranged to engage with the connector member 6 above the first rib 14 to clamp the connector member 6 between the ribs 14, 20. This provides a strong joint between the spoon 2 and the connector member 6. The plug 18 is sealed in place to prevent water and foodstuffs from entering the cavity 10 via the opening 11 since this may lead to the growth of mould and bacteria inside the cavity 10 which could present a health risk to the child.

The handle 8 includes a shallow recess 24 that extends around the circumference of the handle 8 and along a substantial part of the length of the handle. A moulded handgrip 26 is located in the recess to provide improved grip for the child holding the spoon 2. The handgrip 26 is arranged to cover the plug 18 for aesthetic reasons and helps to prevent the ingress of water and foodstuffs to the cavity 10. Preferably the handgrip 26 is made from a plastics material such as a thermoplastic rubber or elastomer such as polyurethane. However any other suitable material can be used.

The connector member 6 connects the spoon 2 to the suction cup 4, and has an elastic or shape memory property that seeks to return the connector member 6 substantially to its original shape or position after it has been stretched. The connector member 6 is elongate. It has a circular cross-section typically in the range 2 to 6 mm, and preferably 4 mm, is coiled having an extended coil length typically in the range 20 to 32 cm, and is made from a phthalate-free PVC material. It has been found that a connector member 6 of this type allows a child to manipulate the spoon 2 to feed him/herself within the normal extensible limit of the connector member 6. The resilient action of the connector member 6 is a slow recoiling action that draws the child's hand downwards in a gentle fashion when the child has delivered the food to his/her mouth and has relaxed his/her arm. In use, the connector member 6 extends as the child lifts his/her hand and resists the child's action thereby restricting the hands movement to guide the hand along a path from a start position adjacent a bowl of food to a final position adjacent the child's mouth. The recoiling action of the connector member 6 activates the motor movement necessary to retract the child's hand to the start position by exerting a pulling force on the child's arm. The recoiling action also guides the child's hand substantially along the same path to the start position as the connector member 6 contracts. Retracting the hand to the start position stimulates the child to begin a subsequent feeding action. Thus, the feeding aid teaches the child the reflexes and coordinated movement required for feeding him/herself with a spoon 2 by instructing the child's brain the path along which the hand must travel from a bowl of food to reach the mouth, and from the mouth back to the bowl of food.

The length of the connector member 6 restricts the amount that the child can move his/her hand. Preferably the length of the connector member 6 is such that the connector member 6 is close to its normal extensible limit when the spoon 2 is positioned at the child's mouth, this is of course in part determined by the position of the suction cup 4 relative to the child. The length of the connector member 6 is also determined by the application, for example a longer connector member 6 may be used with older (larger) children.

Alternatively the connector member 6 may be made from other plastics materials such as other thermoplastic rubbers or elastomers or any other material that activates the extension and recoil action necessary to mimic the reflexes required for feeding.

The slow recoiling action described above is preferable to other embodiments of the invention that include resilient connector members 6 that have stronger elastic properties since such connector members 6 tend to restrict the child's hand movement unnecessarily and the stronger resilient action tends to pull the child's hand downwards more sharply which distracts the child and disrupts the feeding activity. This may increase the time taken to develop feeding skills. If the resilient action is too strong the child may even lose his/her grip on the feeding implement. The slow recoiling action of the connector member 6 described above returns the child's hand slowly to the start position without the child being distracted by the guiding action.

The suction cup 4 is used to anchor the feeding aid to a surface such as a table, a high chair or other non-porous surfaces, and includes a hole 28 located in an upper part. One end of the connector member 6 is threaded through the hole 28 and is welded against itself. Preferably the suction cup 4 is made from a thermoplastic rubber or elastomer such as a phthalate-free PVC material. The suction cup 4 is arranged such that it firmly anchors the spoon 2 to a surface, via the connector member 6, such that in normal use (i.e. when the child is feeding him/herself) the child cannot pull the anchor free from the surface. The suction cup 4 may alternatively be replaced by other means of anchoring the feeding aid to a surface such as a clip or a clamp. The feeding aid may also be attached to a person's clothing using a clip or to a child's wrist using an adjustable bracelet.

The embodiment of the invention described above is relatively lightweight, meets the European and United States destructive tensile test requirements and is easy to clean. The embodiment is also resistant to commonly used sterilizing fluids, can be safely used in sterilizing units that are adapted for use in microwaves, and can be cleaned in a dishwasher.

The feeding aid may include any kind of feeding implement and therefore references to a spoon 2 above should be considered to include knives and forks.

In use, the feeding aid is firmly attached to a surface such as a high chair or table by the suction cup 4. Preferably the suction cup 4 is located adjacent a bowl of food. The child grips the spoon 2 via the moulded handgrip 26 around the handle 8. The child scoops a portion of food onto the spoon 2 and draws the spoon 2 towards his/her mouth. This action stretches the connector member 6 which uncoils and extends its length. As the coil extends it resists the child's movement and guides the child's hand along a path to a position near the child's mouth. When the child has completed the manoeuvre, the child tends to relax his/her arm and the resilient action of the connector member 6 tends to contract the connector member 6 drawing the spoon 2 and child's hand along substantially the same path to the start position which stimulates the child to move his/her arm along the path. This has the effect of teaching the child to return his/her hand to approximately the same position after each feeding action has been completed which stimulates the child to commence a subsequent feeding action. This develops the child's coordination and the child's ability to feed him/herself much more quickly than when using conventional feeding implements by instructing the child the path along which the hand must travel to deliver food from the spoon 2 to his/her mouth, thus developing the reflexes required for feeding.

If the child releases his/her grip on the spoon 2 it will not fall onto the floor but will be suspended above the floor from the surface by the suction cup 4 via the connector member 6.

FIG. 14 shows an alternative embodiment of the invention that uses a different means for attaching the connector member 106 to the spoon 102. The spoon 102 has a handle 108 with a through hole 130. The connector member 106 is threaded through the hole 130 and is attached to itself, preferably by welding, to make a secure connection.

In other respects the second embodiment is similar to the first embodiment.

It will be apparent to the skilled person that other resilient materials can be used for the connector member 6,106 that have elastic or shape memory properties such as rubber and rubber compounds, or devices such as springs, including metallic springs. It is not essential for the connector member to be coiled. It will also be apparent that other ways of connecting the connector member 6,106 to the feeding implement 2,102 can be used.

The feeding aid can be adapted for use with physically impaired people, including adults. Therefore any references to a child above are not to be considered to limit the invention to feeding aids that are suitable only for children. The guiding action of the feeding aid that is used to teach children the reflexes required for feeding themselves with a feeding implement can be adapted to help physically impaired adults to learn or remember (as appropriate) the coordinated movement required to feed themselves. For example, adults who have suffered strokes can be helped to rediscover the muscle control required to move their hand along the correct path from bowl to mouth. Other adults who, because of their impairment, have had difficulty learning to feed themselves using existing aids may also benefit from this invention.

1. A feeding aid for assisting a child or other person to learn how to eat, said feeding aid comprising:
a feeding implement;
an anchor device;
a resilient member comprising an elongate body having a substantially circular cross-section having a diameter in the range 2 to 6 mm, and first and second ends wherein said first end is connected to the anchor device and said second end is connected to the feeding implement, wherein the resilient member is made from a plastics material, is coiled along a substantial part of the length of the elongate body, has an extended coil length in the range 20 to 32 cm to limit the extent of movement of the feeding implement, and includes an elastic or shape memory property that provides, in use, a slow recoiling return action for drawing a user's hand downwards in a gentle fashion.

2-12. (canceled)

13. A feeding aid according to claim 1, wherein the coiled resilient member includes approximately seven turns when in its contracted state.

14. A feeding aid according to claim 1, wherein the resilient member is made from a thermoplastic rubber or elastomer.

15. A feeding aid according to claim 1, wherein the resilient member is made from a phthalate free PVC material.

16. A feeding aid according to claim 1, wherein the anchor device includes a suction device.

17. A feeding aid according to claim 1, wherein the feeding implement includes a cavity having first and second openings and one end of the resilient member is located in the cavity through the first opening and is attached to the feeding implement.

18. A feeding aid according to claim 17, wherein the resilient member is ultrasonically welded to the feeding implement.

19. A feeding aid according to claim 17, wherein a plug is located in the second opening.

20. A feeding aid according to claim 19, wherein the resilient member is clamped between the plug and the feeding implement.

21. A feeding aid according to claim 20, wherein the cavity has a base, and either the cavity base or the plug includes a formation that is arranged to clamp the resilient member against the other of the cavity base and plug.

22. A feeding aid according to claim 21, wherein the cavity has a first formation in its base and the plug has a second formation in its body, wherein the first and second formations are arranged to clamp the resilient member.

23. A feeding aid according to claim 13, wherein the anchor device includes a suction device.

24. A feeding aid according to claim 14, wherein the anchor device includes a suction device.

25. A feeding aid according to claim 15, wherein the anchor device includes a suction device.

26. A feeding aid according to claim 16, wherein the anchor device includes a suction device.

27. A feeding aid for assisting a child, or other person, to learn how to eat, said feeding aid comprising:
a feeding implement;
an anchor device comprising a suction pad;
a resilient member comprising an elongate body having first and second ends, wherein said first end is connected to the anchor device said second end is connected to the feeding implement, wherein the resilient member is made from a plastics material, is coiled along a substantial part of the length of the elongate body, has an extended coil length in the range 20 to 32 cm which limits the extent of movement of the feeding implement, and includes an elastic or shape memory property that provides, in use, a slow recoiling return action for drawing a user's hand downwards in a gentle fashion.

28. A feeding aid according to claim 27, wherein the feeding implement includes a cavity having first and second openings, the second end of the resilient member is located in the cavity through the first opening and is attached to the feeding implement, and a plug is located in the second opening thereby clamping the resilient member between the plug and the feeding implement.

29. A method for teaching a child, or other person, how to eat with an eating implement, said method including providing a feeding aid that includes a feeding implement, an anchor device and a coiled resilient member arranged to connect the feeding implement to the anchor device, wherein the coiled resilient member is constructed and arranged to have a predetermined length that limits the extent of movement of the user's hand and an elastic or shape memory property that provides, in use, a slow recoiling return action for drawing a user's hand downwards in a gentle fashion, said method further including attaching the anchor device to a surface, locating a portion of food adjacent the anchor device, a user removing a quantity of food from the portion of food with the feeding implement, the user moving the feeding implement to deposit the quantity of food into his/her mouth, said movement thereby applying a tensile force to the resilient member and causing at least part of the resilient member to uncoil, and the resilient member slowly recoiling when the force is reduced or removed by the user, said recoiling action drawing the user's hand downwards in a gentle fashion towards a start position adjacent the portion of food.

30. A method according to claim 29, including the user repeating the feeding action and the return action of the resilient member guiding the user's hand to approximately the same start position for at least some of the feeding actions.

31. A method according to claim 30, including the user repeating the feeding action and the return action of the resilient member guiding the user's hand along substantially the same path for at least some of the feeding actions.

32. A method according to claim 29, wherein the resilient member comprises an elongate body having first and second ends, wherein said first end is connected to the anchor device said second end is connected to the feeding implement, wherein the resilient member is coiled along a substantial part of the length of the elongate body, has an extended coil length in the range 20 to 32 cm, and is made from a plastics material.

33. A method according to claim 32, wherein the elongate body has a substantially circular cross-section having a diameter in the range 2 to 6 mm.

34. A method according to claim 32, wherein the anchor device comprises a suction pad.

35. A method according to claim 32, wherein the feeding implement includes a cavity having first and second openings, the second end of the resilient member is located in the cavity through the first opening and is attached to the feeding implement, and a plug is located in the second opening thereby clamping the resilient member between the plug and the feeding implement.

36. A method for teaching a child, or other person, how to eat with an eating implement, said method including providing a feeding aid that includes a feeding implement, an anchor device and a resilient member arranged to connect the feeding implement to the anchor device, wherein the resilient member is constructed and arranged to have a predetermined length that limits the extent of movement of the user's hand and an elastic or shape memory property that provides, in use, a slow return action for drawing a user's hand downwards in a gentle fashion, said method further including attaching the anchor device to a surface, locating a portion of food adjacent the anchor device, a user removing a quantity of food from the portion of food with the feeding implement, the user moving the feeding implement to deposit the quantity of food into his/her mouth, said movement thereby applying a tensile force to the resilient member and causing the resilient member to extend, and the resilient member slowly contracting when the force is reduced or removed by the user to provide a return action that pulls the user's hand downwards in a gentle fashion towards a start position adjacent the portion of food, the method further including the user repeating the feeding action and the return action of the resilient member guiding the user's hand along substantially the same path to approximately the same start position for at least some of the feeding actions.
